(19) United States
(12) Patent Application Publication
(10) Pub. No.: US 2009/0124395 A1
(43) Pub. Date: May 14, 2009

(54) LCD MOUNTING SYSTEM FOR A GAMING APPARATUS

(76) Inventors: Dugan S. O'Keene, Forest Park, IL (US); Peter Dorn, Wood Dale, IL (US); Scott M. Irving, Roselle, IL (US); John J. Beirne, St. Charles, IL (US)

Correspondence Address: BRINKS HOFER GILSON & LIONE, P.O. BOX 10395, CHICAGO, IL, 60610, US

(21) Appl. No.: 12/264,617

(22) Filed: Nov. 4, 2008

Related U.S. Application Data
(60) Provisional application No. 60/985,810, filed on Nov. 6, 2007.

(51) Int. Cl. G06F 17/00

(52) U.S. Cl. 463/46

(57) ABSTRACT

A gaming apparatus having a cabinet cooperatively coupled to an LCD mounting system. The LCD mounting system is carried within and mounts to an interior surface of the cabinet. The LCD mounting system is pivotable relative to and independent from the cabinet and a door mounted thereto. In this way, when the door is in an open position, a video display supported by the LCD mounting system may pivot away from the cabinet to allow access to an interior space and the components within the cabinet. Alternatively, when the door is in an open position, the video display supported by the LCD mounting system may be positioned for easy viewing and interaction while still allowing access to the interior space and the components within the cabinet.

### CROSS REFERENCE TO RELATED APPLICATION

This patent claims the priority benefit under 35 U.S.C. §119(e) of U.S. provisional patent application Ser. No. 60/985,810, submitted on Nov. 6, 2007; the content of which is hereby incorporated by reference for all purposes.

### TECHNICAL FIELD

The present disclosure generally provides a mount for an LCD, and more particularly a pivotably adjustable LCD mount configured to cooperate with a gaming apparatus cabinet.

### BACKGROUND

Gaming apparatuses or machines such as slot machines, video slot machines, video gaming terminals and the like are common fixtures within gambling casinos.

U.S. Pat. No. 6,860,814 discloses one known gaming apparatus that includes a cabinet and a door connected to the cabinet, the door moveable between a first position and a second position. In a first position, the door cooperates with the cabinet to define a generally closed interior space. In a second position, the door permits access to the interior space. The door has an opening therein. A thin video display is mounted to an inside of the door in alignment with the opening therein. The use of the video display and its mounting permits the depth of the cabinet to be substantially reduced. In one embodiment, the width of the cabinet exceeds its depth. Systems such as these allow easy access to the interior space of the cabinet but can make it difficult to service and/or maintain the gaming apparatus while interacting with the video display.

U.S. patent application publication No. 2005-0277477 A1 discloses a gaming machine cabinet configured to utilize extendable displays that allow viewing and operation of the video display with the game machine cabinet door open. Many gaming machines, in particular those with flat-panel displays, have the flat-panel display mounted in the gaming cabinet door itself. When the door is opened, the display is no longer visible to technicians as they work on the interior components of the gaming machine. To solve this problem, the video display is pivotally mounted in the cabinet door to allow the video display to be released and rotated into a position viewable by the technician with the gaming cabinet door open.

It would be desirable to provide a gaming apparatus that addresses and overcomes the limitations of the known gaming apparatuses.

### SUMMARY

The present disclosure provides a gaming apparatus having a cabinet cooperatively coupled to an LCD mounting system. The exemplary LCD mounting system is carried within and mounts to an interior surface, an interior component or other interior element of the cabinet. The LCD mounting system, in turn, may be pivoted relative to and independent from the cabinet and a door mounted thereto. In another embodiment, the LCD mounting system may pivot, rotate, linearly translate or slide and/or telescope relative to the cabinet and the door. In this way, when the door is in an open position, a video display supported by the LCD mounting system may pivot away from the cabinet to allow access to an interior space and the components within the cabinet. Alternatively, when the door is in an open position, the video display supported by the LCD mounting system may be positioned for easy viewing and interaction while still allowing access to the interior space and the components within the cabinet. In yet another embodiment, the LCD mounting system may allow the video display to pivot about one or more axes and linkages. Moreover, the LCD mounting system may be configured to allow or provide for linear to telescopic translation of the video display relative to the cabinet and door.

Other embodiments are disclosed, and each of the embodiments can be used alone or together in combination. Additional features and advantages of the disclosed embodiments are described in, and will be apparent from, the following Detailed Description and the figures.

### BRIEF DESCRIPTION OF THE FIGURES

FIG. 1 illustrates a gaming apparatus constructed in accordance with the teachings disclosed herein;

FIG. 2 illustrates an interior space of the gaming apparatus and a mounting system carrying a video display shown in FIG. 1;

FIG. 3 illustrates a cutaway view of the gaming apparatus and a mounting system shown in FIGS. 1 and 2;

FIG. 4 illustrates a front perspective view of the exemplary mounting system;

FIG. 5 illustrates a rear perspective view of the mounting system shown in FIG. 4;

FIG. 6 illustrates a top view of the mounting system shown in FIGS. 4 and 5;

FIG. 7 illustrates an enlarged rear perspective view of the mounting system shown in FIGS. 4 and 5; and

FIG. 8 illustrates another enlarged rear perspective view of the mounting system shown in FIGS. 4 and 5.

### DETAILED DESCRIPTION

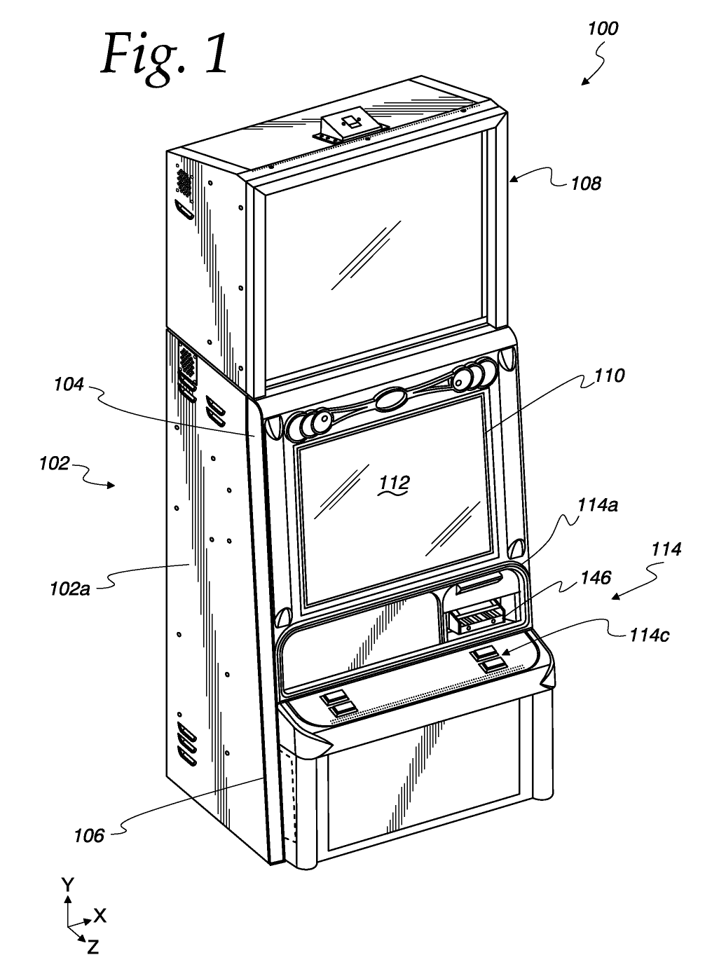

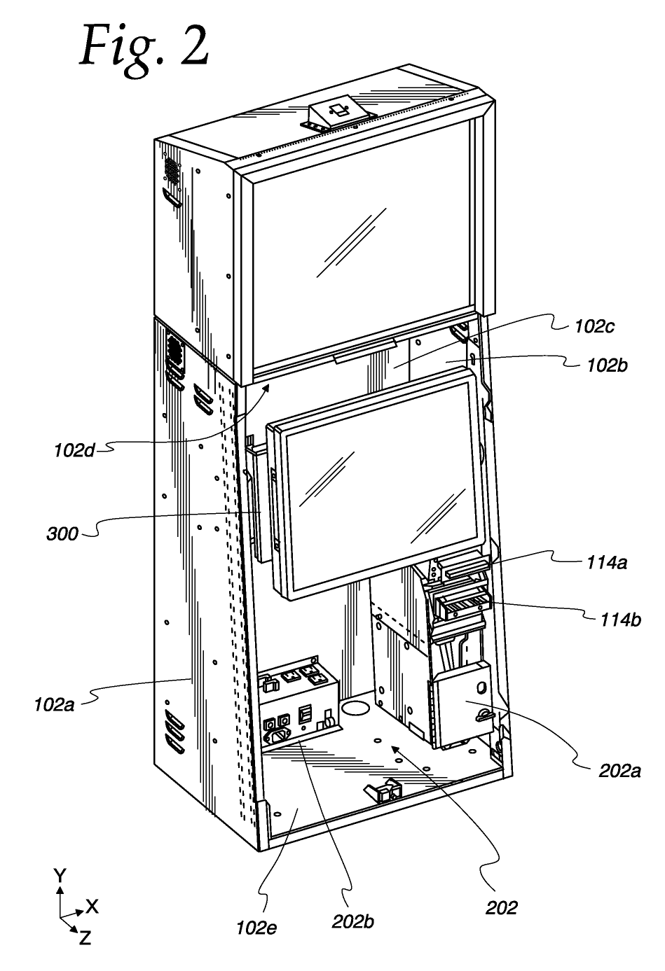

FIG. 1 illustrates a perspective view of a gaming apparatus 100 having a cabinet 102 coupled to a door 104 via a hinge 106. The cabinet 102 may include a pair of elongated side panels 102a, 102b (see FIG. 2) disposed along either edge of an elongate back panel 102c (see FIG. 2). The cabinet 102 may further include a top panel 102d (see FIG. 2) and a bottom panel 102e (see FIG. 2) cooperating with the side and back panels 102a, 102b and 102c.

The top panel 102d of the cabinet 102 may carry and support a marquee 108 adapted to, for example, attract players, provide additional game play options and/or display other additional information. The marquee 108 may include, for example, a light tower (not shown) configured to indicate a machine status, a payout status or state, or any other desirable functionality or indication.

In an embodiment, the top panel 102d may be a smaller panel relative to the bottom panel 102e. In this exemplary embodiment both the top and bottom panels 102d and 102e may cooperate with the back panel 102c; the side panels 102a and 102b may, in turn, include a slanted edge to connect the smaller top panel 102d to the larger bottom panel 102e. In this way, the cabinet 100 and the hingedly connected door 104 may be inclined away from a user (not shown).

The door 104 may be pivotably attached to the side panel 102a via the hinge 106. The door 104, in FIG. 1, is illustrated in a closed position adjacent to the cabinet 102. The door 104 may be pivoted or moved about the hinge 106 to an open position away from the cabinet 102. The door 104 may include a cut out 110 sized to cooperate with a video display 112 such as, for example, an LCD (liquid crystal display). The door 104 may further include a control panel 114 positioned for easy and/or comfortable access by the user (not shown). The control panel 114 may include, for example, a card reader 114a, a bill acceptor 114b and user controls 114c such as, for example, buttons, instructions and/or other mechanisms to facilitate game play.

FIG. 2 illustrates a perspective view of the gaming apparatus 100 where the door 104 is removed from the hinge 106 to expose an interior space 200 of the cabinet 102. The interior space 200 shelters and carries the hardware and componentry associated with the card reader 114a, the bill acceptor 114b and the user controls 114c. The interior space 200 may further include gaming components 202 such as, for example, a lock box 202a configured to store and secure bills and other tender received via the bill acceptor 114b and a power or networking hub 202b. Additional componentry, electronics, power supplies, etc., may be positioned in carried within the interior space 200.

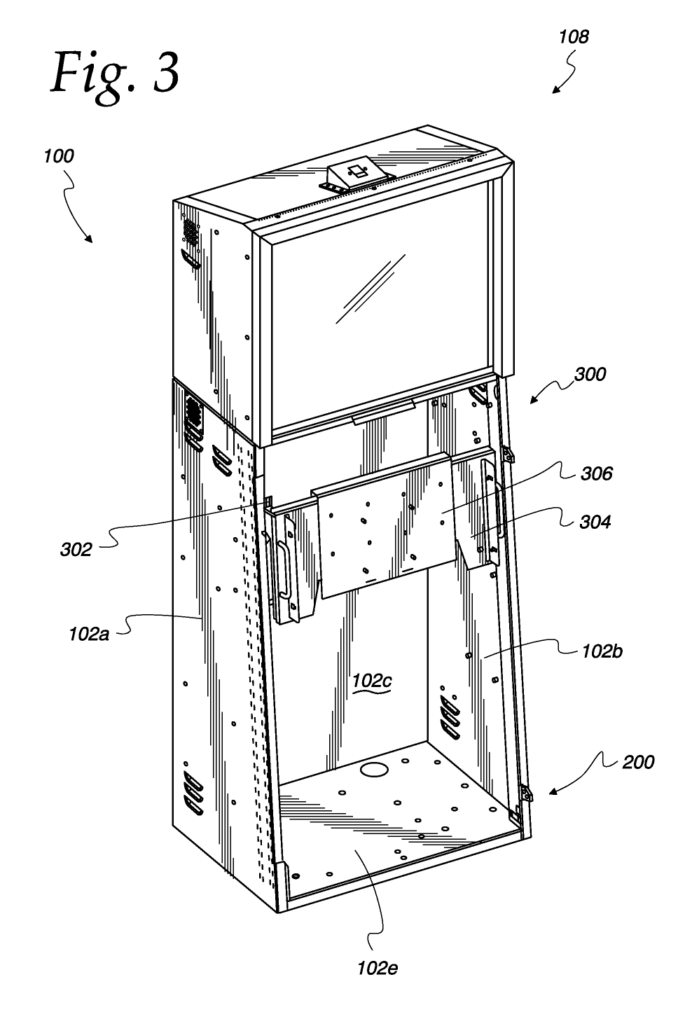

The video display 112 may be affixed to, for example, the side panel 102a of the cabinet 102 via a mounting system 300 (see FIG. 3). In this way, the video display 112 may be supported and carried independent of the door 104. Thus, when the door 104 pivots to the open position (away from the cabinet 102 and side panel 102b), the video display 112 may remain accessible within the interior space 200.

FIG. 3 illustrates a semi-transparent perspective view of the gaming apparatus 100 cooperatively coupled to the mounting system 300 which, in turn, carries the video display 112. The mounting system 300 includes a bracket 302 configured to be secured to the side panel 102a of the cabinet 102. In this way, the mounting system 300 and the video display 112 are independently movable relative to the door 104. In an alternative embodiment, the bracket 302 may be securable to the top panel 102d such that the video display 112 may be vertically movable to a position substantially parallel and/or adjacent to the marquee 108. The bracket 302 may, for example, be fabricated from twelve (12) gauge sheet metal, cold rolled steel (C.R.S.), (ASTM A1008), etc., and may be galvanized (ASTM A653) or painted to prevent corrosion. The individual components of the mounting system 300 may be manufactured from, for example, C.R.S. of differing thicknesses based on the calculated strength requirements. However other materials could be used to produce the same effective parts.

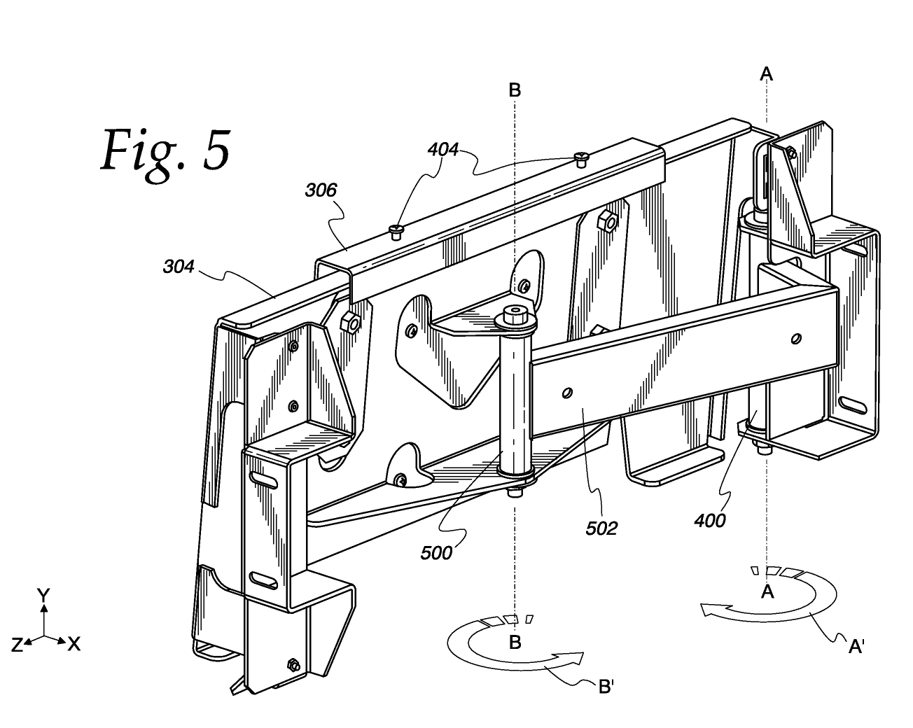

When affixed to the cabinet 102, the bracket 302 abuts and connects the mounting system 300 to the side panel 102a. The bracket 302 may be removably attached to the side panel 102a utilizing fasteners, screws or other known joining mechanisms. In another embodiment, the bracket 302 may be fixedly attached to the side panel 102a via rivets, welding or other permanent joining means. The mounting system 300 includes a support 304 movable and pivotable in an arc relative to both the bracket 302, a pivot bar 502 (see FIG. 5), and the side panel; 102 a of the cabinet 102. The support 304 may carry a mounting bracket 306 configured to support and secure the video display 112.

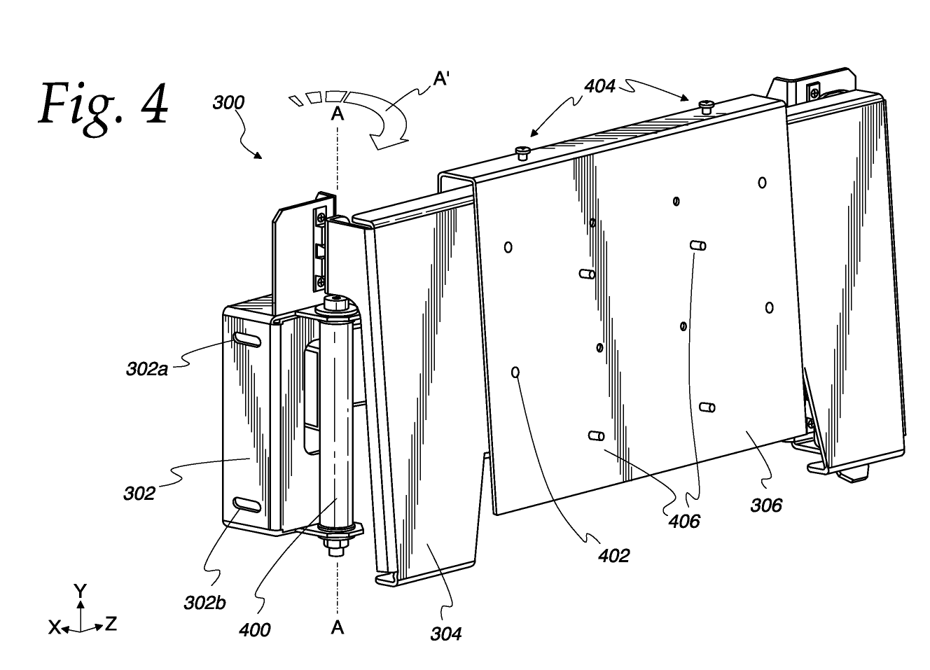

FIG. 4 illustrates a perspective view of the mounting system 300 disposed away from the cabinet 102. As previously discussed, the bracket 302 may be removably attached to the side panel 102a of the cabinet 102 via mounting holes 302a and 302b. The support 304 may be pivotably attached to the bracket 302 via rotational coupler 400. For example, the support 304 may rotate about the axis A-A in the direction indicated by the arc A′. As previously discussed, this allows the door 104 to open and pivot about the hinge 106 while simultaneously allowing the support 304 (and the attached video display 112) to independently rotate relative to the door 104 and the cabinet 102.

The mounting bracket 306 may be removably mounted to the support 304. The mounting bracket 306 may be customized to support a variety of video displays 112. For example, the mounting holes 402 and/or mounting pins 406 may be positioned to engage the complimentary mounting mechanism provided upon the video display 112. The mounting bracket 306 may further include one or more leveling screws 404 which may be utilize to fine-tune or adjust the tilt and angle of the video display 112 relative to, for example, the cut out 110. The mounting bracket 306 may be replaced or swapped out depending upon the video display 112 utilized within the gaming apparatus 100. In this way, the mounting system 300 may accommodate upgrades and maintenance on the gaming apparatus 100.

FIG. 5 illustrates a reverse perspective views of the mounting system 300. In this embodiment, the support 304 is pivotably coupled to the bracket 302 and the rotational coupler 400 via a second rotational coupler 500. In particular, a rigid support or pivot bar 502 adjoins and spaces apart the rotational couplers 400 and 500 thereby allowing the support 404 to be positioned with two (2) degree of freedom. For example, while the support 304 and accompanying hardware may rotate about the axis A-A, and may further rotate about an axis B-B in the direction indicated by the arc B′. It should be noted that the arc A′ and the arc B′ indicate opposing directions of rotation thereby allowing the support 304 to be rotated in a substantially complete circle. Thus, when the door 104 is in the open position (away from the cabinet 102) the mounting system 300 may be adjusted to position the video display 112 adjacent to the door 104. Alternatively, the video display 112 may be rotated about the axis B to allow a user facing the interior space 200 to view and/or interact with the video display 112. The pivot bar 502 may be manufactured from multiple individual components which may, in turn, be welded or otherwise joined together to form one rigid piece. The material utilized to manufacture the pivot bar 502 may be, for example, a rectangular steel tube 0.75″×2.0″×0.083 wall thickness. Similarly, the rotational couplers 400, 500 may be manufactured from a cold drawn seamless steel tube 0.75″ outer diameter, 0.50″ inner diameter. However other materials and dimensions could be used to produce the same effective parts. The rotational couplers 400, 500 may be custom designed and fabricated components configured to support the anticipated load and provide the desired rotation freedom. In an alternate embodiment, the rotational couplers 400, 500 may be ball couplers or pivots which could allow the video display 112 to be rotated through more than two degrees of freedom and into a plane aligned with the support 304.

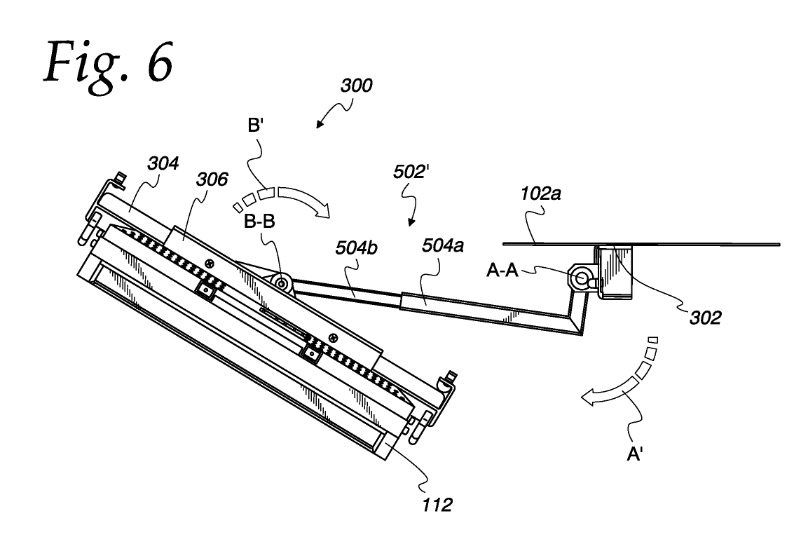

FIG. 6 illustrates a top plan view of the mounting system 300, including an exemplary video display 112, coupled and pivotable relative to the side wall 102a. In this exemplary embodiment, the relative degrees of freedom between the side wall 102a and the video display 112 may be understood as the mounting system 300 pivots about both the axis A-A and the axis B-B as indicated by the arrows A′ and B′, respectively. Moreover, in this exemplary embodiment, the pivot bar 502 is a telescoping pivot bar 502′. The telescoping pivot bar 502′ includes first and second sections 504a and 504b. For example, the second section 504b may be substantially enclosed by, and linearly slideable relative to, the first section 504a. Thus, when it is desirable to adjust the linear position of the video display 112 relative to the bracket 302, the second section 504b may extended relative to the first section 504a.

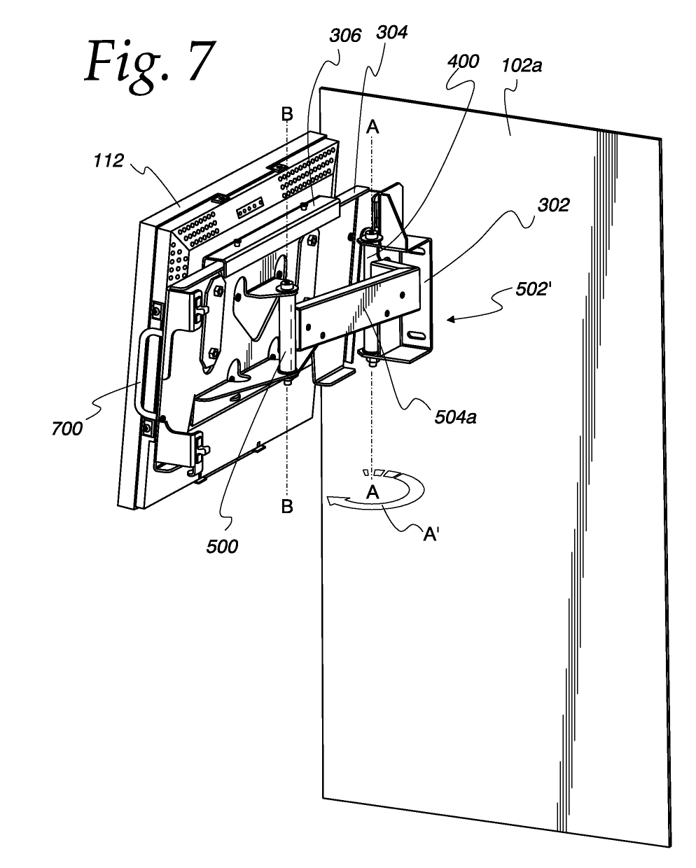

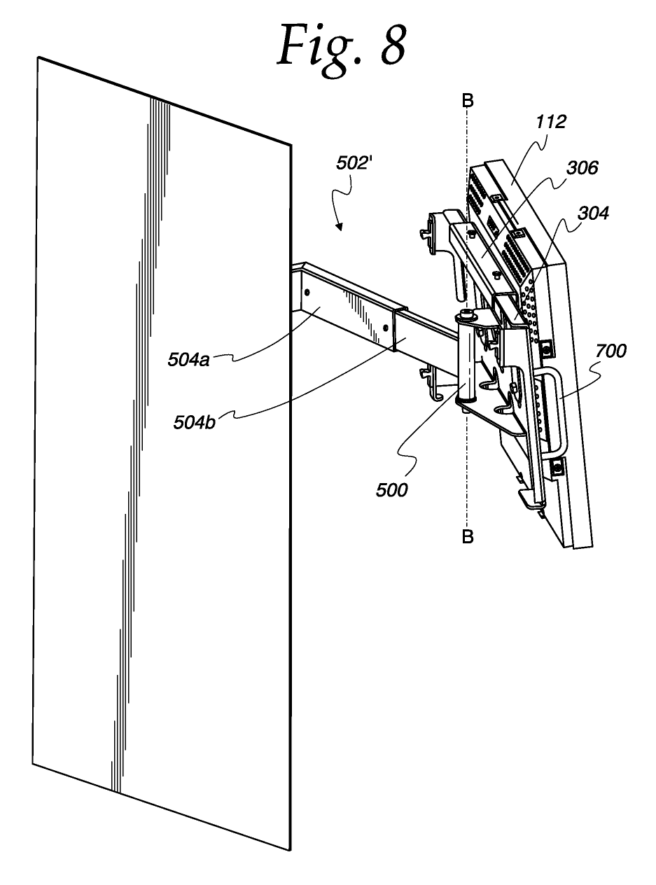

FIGS. 7 and 8 illustrate the mounting system 300 including the telescoping pivot bar 502′. FIG. 7 illustrates the mounting system 300 pivotably rotated about the axis A-A relative to the side panel 102a and the bracket 302. FIG. 8 illustrates the mounting system 300 pivotable rotated about both the axis A-A (see FIG. 7) and axis B-B thereby displaying two (2) degrees of rotational freedom as well as the linear extendability provided by the telescoping pivot bar 502′. FIGS. 7 and 8 further illustrate an adjustment handle or handle 700 coupled to the support of the mounting system 300. The handle 700 may be utilized to adjust, move and otherwise position the video display 112 and the mounting system 300 without physically grasping and potentially damaging the video display 112.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

What is claimed is:

1. A gaming apparatus comprising:
a cabinet defining an interior space;
a door pivotably coupled to at least one portion of the cabinet, wherein the door is movable between a closed position and an open position; and
a mounting system configured to support a video display, wherein the mounting system is carried within the interior space of the cabinet, and wherein the mounting system is pivotable relative to the door and the cabinet.

2. The gaming apparatus of claim 1, wherein the video display is pivotable relative to the mounting system and the cabinet.

3. The gaming apparatus of claim 1, wherein the mounting system is configured to include a first degree of freedom and a second degree of freedom relative to the cabinet.

4. The gaming apparatus of claim 1, wherein the mounting system includes a telescoping pivot bar.

5. The gaming apparatus of claim 1, wherein the mounting system further comprises a mounting bracket configured to support the video display.

6. The gaming apparatus of claim 1, wherein the mounting system includes further comprises an adjustment handle disposed substantially adjacent to the video display.

7. A gaming apparatus comprising:
a cabinet defining and interior space;
a door pivotably coupled to the cabinet, wherein the door is movable between a closed position and an open position; and
a mounting system configured to support a video display, wherein the mounting system is carried within the interior space of the cabinet, and wherein the mounting system is pivotable relative to the cabinet, and wherein the video display is pivotable relative to the mounting system.

8. The gaming apparatus of claim 7, wherein the mounting system is configured to include a first degree of freedom and a second degree of freedom relative to the cabinet.

9. The gaming apparatus of claim 7, wherein the mounting system includes a telescoping pivot bar.

10. The gaming apparatus of claim 7, wherein the mounting system further comprises a mounting bracket configured to support the video display.

11. The gaming apparatus of claim 7, wherein the mounting system includes further comprises an adjustment handle disposed substantially adjacent to the video display.

12. A mounting system comprising:
a bracket configured to engage an interior of a gaming device cabinet;
a first rotation coupler carried by the bracket;
a pivot bar coupled to the first rotational coupler at a first end and pivotable thereabout;
a second rotation coupler carried by the pivot bar at a second end, wherein the second rotation coupler is pivotable relative to the pivot bar and the first rotation coupler;
a support coupled to the second rotational coupler, wherein the support is configured to carry a video display, and wherein the video display is pivotable about the second rotation coupler relative to the pivot bar, the first rotation coupler and the bracket.

13. The gaming apparatus of claim 12, wherein the pivot bar is a telescoping pivot bar.

14. The gaming apparatus of claim 12, wherein the mounting system further comprises a mounting bracket configured to support the video display.

15. The gaming apparatus of claim 12, wherein the mounting system includes further comprises an adjustment handle disposed substantially adjacent to the video display.
